(19) United States
(12) Patent Application Publication
(10) Pub. No.: US 2005/0181090 A1
(43) Pub. Date: Aug. 18, 2005

(54) Injection molding nozzle with embedded and removable heaters

(75) Inventor: George Olaru, Toronto (CA)

Correspondence Address: STERNE, KESSLER, GOLDSTEIN & FOX PLLC, 1100 NEW YORK AVENUE, N.W., WASHINGTON, DC, 20005, US

(73) Assignee: Mold-Masters Limited

(21) Appl. No.: 10/726,482

(22) Filed: Dec. 4, 2003

Related U.S. Application Data
(60) Provisional application No. 60/431,242, filed on Dec. 6, 2002.

(51) Int. Cl. B29C 45/20

(52) U.S. Cl. 425/549; 425/570; 425/572; 239/135

(57) ABSTRACT

An injection molding heated nozzle having a nozzle body defining an melt bore having an entry end and an exit end; a first heater carried by the nozzle body for heating the nozzle body along a length of the melt bore; and a second heater removably mounted to the nozzle body for heating the nozzle body, at least a portion of the second heater overlapping a portion of the first heater.

### CROSS-REFERENCE TO RELATED APPLICATIONS

The present application claims the benefit under 35 U.S.C. §119(e) of U.S. Application No. 60/431,242 filed Dec. 6, 2002. The disclosure of this referenced application is incorporated by reference herein in its entirety.

### BACKGROUND OF THE INVENTION

This invention relates generally to injection molding and more particularly to an injection molding nozzle having more than one heating element.

High reliability is critical in most injection molding applications. Failure of a component in an injection molding system results in lost output during the time it takes to detect what component has failed, replace the component and restart the molding process. Failure of the heating element for a hot runner injection molding nozzle during the molding operation can result in costly process interruptions.

There are generally two types of heaters for providing heat along the melt channel of a hot runner nozzle. The first type includes external heaters that are located outside of but in intimate contact with the outer surface of the nozzle body. External heaters typically can be removed from the injection molding system independently of the hot runner nozzle. Examples of external heaters can be seen in the following patents: U.S. Pat. No. 5,360,333 issued Nov. 1, 1994; U.S. Pat. No. 5,411,392 issued May 2, 1995; U.S. Pat. No. 6,409,497 issued Jun. 25, 2002; U.S. Pat. No. 4,940,870 issued Jul. 10, 1990; U.S. Pat. No. 6,163,016 issued Dec. 19, 2000; U.S. Pat. No. 4,268,241 issued May 19, 1981; and U.S. Pat. No. 6,043,466 issued Mar. 28, 2000 (the contents of all of which are incorporated herein by reference). Removable external heaters can typically be removed and replaced independently of the nozzle when a heater malfunctions. However, the use of a heater external to and removable from the nozzle can introduce heat transfer variables that can be difficult to predict and control, resulting in undesirable or unintended heat profiles along the nozzle body.

The second type of nozzle heaters includes embedded heaters that are embedded or at least partially embedded in the nozzle body. Embedded heaters include heaters that are internally embedded or cast in the nozzle body, examples of which can be seen in U.S. Pat. No. 4,238,671 issued Dec. 9, 1980; U.S. Pat. No. 4,386,262 issued May 31, 1983; U.S. Pat. No. 4,403,405 issued Sep. 13, 1983 and U.S. Pat. No. 6,394,784 issued May 28, 2002 (the contents of all of which are incorporated herein by reference). Embedded heaters also include heaters that are embedded or partially embedded in an outer surface of the nozzle body. Examples of surface embedded heaters can be seen in EP 1 252 998 A2 published Oct. 30, 2002 and U.S. Pat. No. 5,046,942 issued Sep. 10, 1991; U.S. Pat. No. 6,162,043 issued Dec. 19, 2000; U.S. Pat. No. 5,266,023 issued Nov. 30, 1993; U.S. Pat. No. 5,704,113 issued Jan. 6, 1998; U.S. Pat. No. 4,771,164 issued Sep. 13, 1998; 5,614,233 issued Mar. 25, 1997; U.S. Pat. No. 4,768,283 issued Sep. 6, 1988; U.S. Pat. No. 5,235,737 issued Aug. 17, 1993; U.S. Pat. No. 4,557,685 issued Dec. 10, 1985; U.S. Pat. No. 5,282,735 issued Feb. 1, 1994; and U.S. Pat. No. 5,046,942 issued Sep. 10, 1991 (the contents of all of which are incorporated herein by reference). Embedded heaters can often provide a better and more predictable heat transfer to the nozzle body than an external heater, but generally cannot be replaced independently of the nozzle. Some embedded heaters consist of elongate cartridges that are inserted into bores in the nozzle body that run parallel to the nozzle melt bore.

Attempts have been made at designs that permit a quick replacement of a nozzle heater by providing access to the nozzle from a mold side of the injection molding system. For example U.S. Pat. No. 6,162,043 issued Dec. 19, 2000 (the contents of which are incorporated herein by reference) discloses an injection molding apparatus in which a hot runner nozzle with an embedded heater has a threaded upper end such that it can be screwed in and out of the injection molding apparatus from a mold side thereof. U.S. Pat. No. 6,043,466 issued Mar. 28, 2000 shows an example of an externally mounted heater that can be accessed from the mold side. U.S. Pat. No. 6,309,207 issued Oct. 30, 2001 and U.S. Pat. No. 5,533,882 issued Jul. 9, 1996 (the contents of which are incorporated herein by reference) also show systems in which access from a mold side is provided to the nozzle heater.

In order to provide redundancy and avoid process interruptions due to heater failure, designs have been proposed in which two overlapping embedded heaters are provided along the heater nozzle, as shown for example, in the above mentioned U.S. Pat. No. 6,394,784 and EP patent application EP 1 252 998 A2. However, such solutions are limited by the size of the nozzle and do not provide the option of replacing the heater independent of the nozzle.

A common concern in hot runner nozzles is to provide a uniform heat profile along the length of the nozzle body, especially in areas of the nozzle body such as its tip and head that are close to heat losing contact points with the rest of the injection molding system.

Thus there is a need for a hot runner nozzle heating system which provides a high degree of reliability, predictable and efficient heat transfer, and which can be quickly repaired in the event of a failure. A heating system that can provide an efficient heat profile along the length of the hot runner nozzle is also desirable.

### SUMMARY OF THE INVENTION

The present invention provides a hot runner nozzle that has at least two heaters, one of which is embedded or partially embedded in the nozzle body or in contact with the outer surface of the nozzle body, and the other of which is a replaceable heater that is located over the nozzle body. The replaceable heater may be configured so that it can be removed from the injection molding apparatus independently of the hot runner nozzle. The at least two heaters may be configured and calibrated to provide redundant heating functions and act as backup for each other, or to work in conjunction with each other. Each of the heaters could include more than one independent electrically resistive heating wires to provide further redundancy.

According to one aspect of the invention, there is provided an injection molding heated nozzle that includes a nozzle body defining a melt bore having an entry end and an exit end, a first heater carried by the nozzle body for heating the nozzle body along a length of the melt bore, and a second heater removably mounted to the nozzle body for heating the nozzle body, at least a portion of the second heater overlapping a portion of the first heater.

Other aspects and features of the present invention will become apparent to one of ordinary skill in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached Figures, wherein:

FIG. 1 is a simplified cross-sectional view of a pair of nozzle assemblies in accordance with the present invention;

FIG. 2 is a partially exploded perspective view showing a nozzle according to the present invention ready for assembly;

FIG. 3 is a simplified sectional view of the nozzle of FIG. 2; and

FIGS. 4-7 are each simplified sectional views of nozzles according to a further embodiments of the invention.

### DETAILED DESCRIPTION

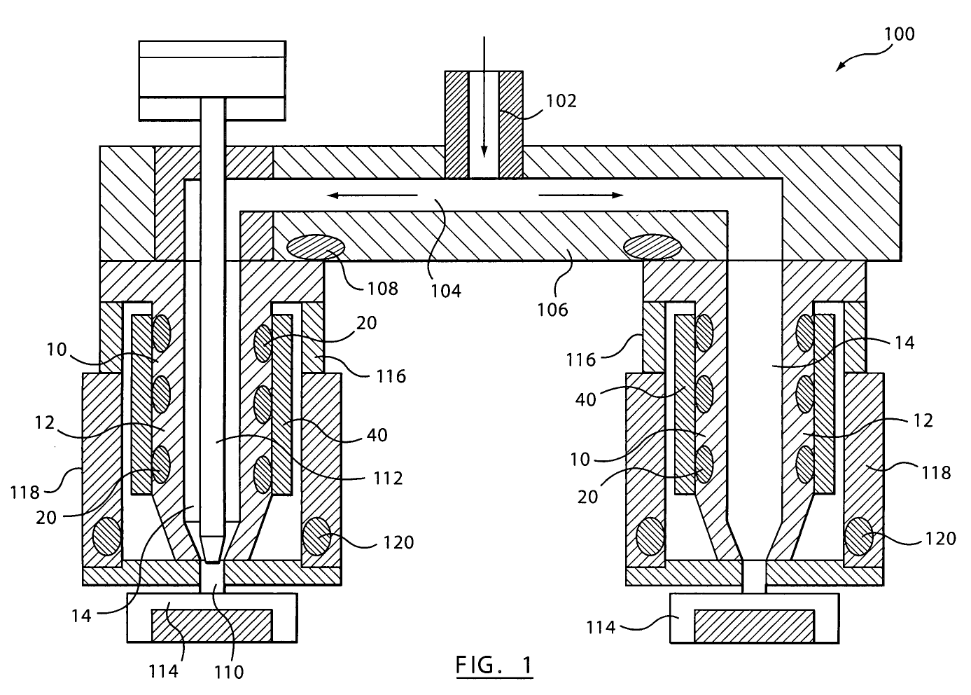

FIG. 1 shows, indicated generally by 100, a simplified view of a hot runner injection molding system showing aspects of the present invention. The system 100 includes a melt passage 102 that branches out into the passages of a manifold melt chamber 104 provided through manifold 106. Manifold 106 is heated by manifold heaters 108. Each of the passages of the manifold melt chamber 104 communicates with a respective nozzle melt bore 14 passing through a respective hot runner nozzle 10. The melt bore 14 of each nozzle communicates through a respective mold gate 110 with a mold cavity 114. Spacer plates or flanges 116 and a cavity plate 118, through which cooling channels 120 may be provided, define nozzle cavities in the system 100.

As shown in FIG. 1, one nozzle 10 is thermal gated and the other nozzle 10, which includes valve pin 112, is valve gated. In practice, the two types of gating are generally not used in the same system, however are shown in FIG. 1 to demonstrate that the heating configuration of the present invention can be applied in different gating configurations.

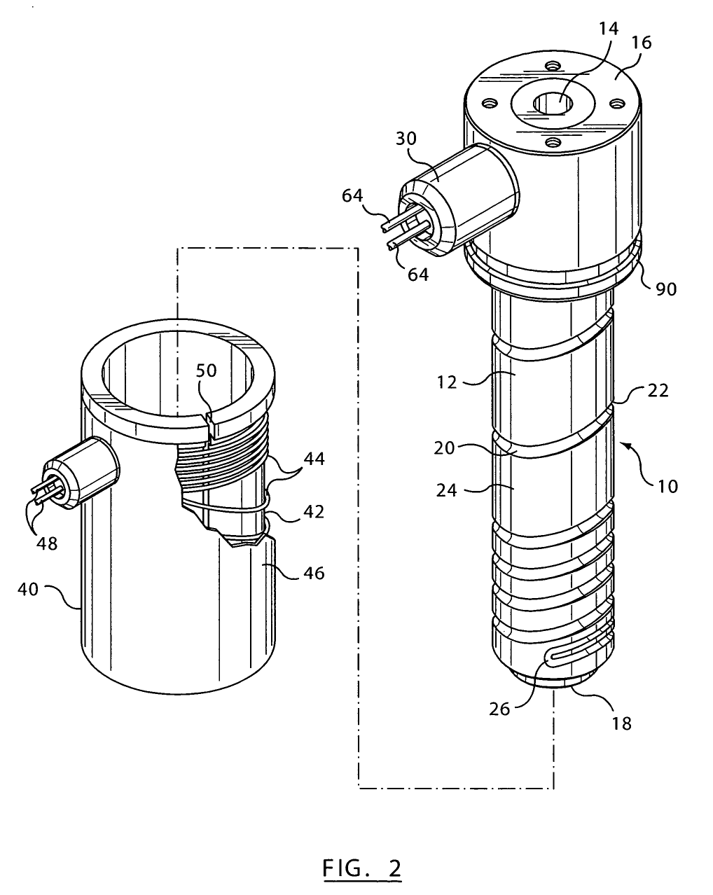

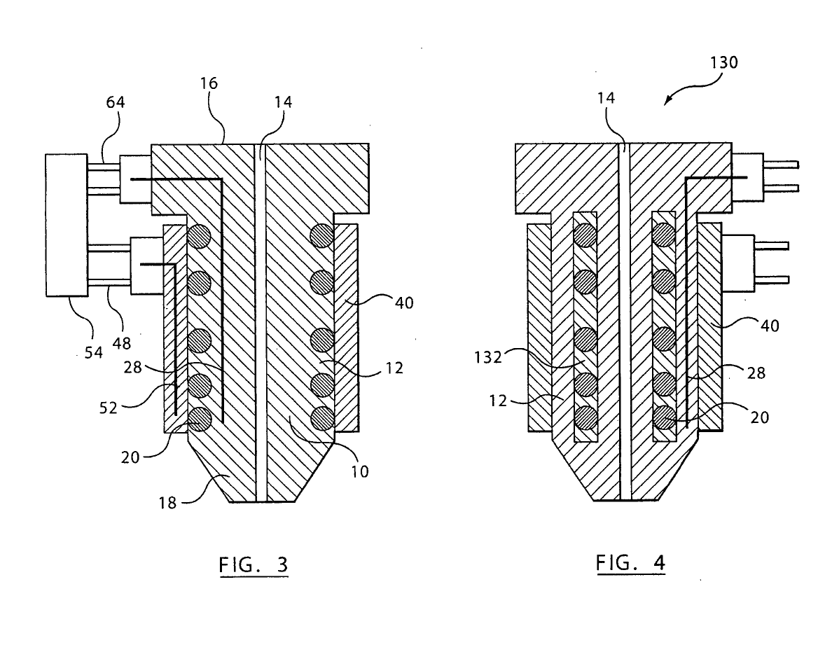

With reference to FIGS. 2 and 3, nozzle 10 has a steel body 12 through which the melt bore 14 extends from a melt entry end 16 to a melt exit end 18. An electrical heating element 20, such as a resistive wire, is press fitted in a spiral channel 22 which extends around the outer surface 24 of the nozzle body 12. In the embodiment of FIG. 2, the heating element 20 has a U-shaped bend 26 near the exit end 18 of the steel body 12, and two ends that extend from the body through a terminal housing 30, near the entry end 16, as electrical terminals 64. A steel collar 90 may be provided at the entry end 16 of the nozzle. A thermocouple 28 is preferably provided through the steel body 12, parallel to melt channel 14, for providing feedback indicative of the temperature of the nozzle 10.

According to embodiments of the invention, an external removable clamp heater 40 is provided over the steel body 12 of the nozzle 10, and clamped to its outer surface 24. The clamp heater 40 shown in FIG. 2 includes an inner sleeve 42 formed from a high heat conductivity material, which is placed in tight contact with the outer surface 24 of the nozzle body 12. A heating element 44 spirals around the inner sleeve, and is surrounded by an outer sleeve 46. Two ends of the heating element extend from the clamp heater 40 as electrical terminals 48. In the illustrated embodiment, the inner sleeve 42 includes an axial slot 50 to facilitate mounting and removal of the clamp heater 40 on the nozzle body 12. A compressive device such as a corrugated wall (not shown) may be located between the outer sleeve 46 and the heating element 44 to clamp the clamp heater in place, or other clamping configurations may be used such that the clamp heater 40 can be removed from the nozzle 10 and replaced. The clamp heater preferably includes thermocouple 52 (FIG. 3) for monitoring the temperature of the clamp heater 40. With reference to FIG. 1, preferably at least a lower portion of the cavity plate 118 is removable or otherwise configured to allow access to the nozzle 10 from a mold side of the injection molding system 100 so that the clamp heater 40 can be removed and replaced independently of the nozzle 10.

The embedded heater 20 and clamp heater 40 are both positioned to provide heat along the same portions of the nozzle body 12 surrounding the melt bore 14. Preferably, the clamp heater and embedded heater are pre-calibrated so that when operated independently they each provide an identical or similar heat profile along the melt bore. With reference to FIG. 3, a controller 54 is operatively connected to the electrical terminals 48 and 64 of external clamp heater 40 and embedded heater 20, respectively, and is connected to receive feedback signals from temperature sensing thermocouples 28 and 52.

In one mode of operation, the heating for the nozzle 10 is provided by embedded heater 20. In the event that feedback from thermocouple 28, when compared against a predetermined threshold value, indicates that embedded heater 20 has partially or completely failed, the controller 54 is configured to automatically switch power from embedded heater 20 to clamp heater 40, with minimal or no disturbance to the molding process. The controller 54 can monitor thermocouple 52 to track operation of the clamp heater 40. In the event that clamp heater 40 then fails, it can be removed from the nozzle 10 and replaced, without requiring the nozzle to be replaced, thereby reducing downtime. The nozzle 10 can subsequently be replaced with a nozzle having a working embedded heater during a scheduled maintenance downtime.

The use of an embedded heater in combination with a backup external removable heater can provide a design in which improved heat transfer characteristics of an embedded heater are normally realized. However, if the embedded heater fails, the backup clamp heater can take over without stopping the molding process.

In some embodiments, the embedded heater may act as the backup heater to the external clamp heater. In some embodiments, the embedded heater and the clamp heater may work simultaneously to improve the heat profile along the length of the nozzle melt bore and provide extra heating in areas of the nozzle where heat escapes faster, for example near the gate 110, and near the entry end 16.

Two thermocouples 28 and 52 are shown in the nozzle 10 of FIG. 3. The thermocouples can, in some embodiments, act as backups for each other independently of the heater operation. For example embedded thermocouple 28 may fail, but embedded heater 20 still be functional. The controller 54 could be configured to, upon detecting an out of range or loss of signal from embedded thermocouple 28, check a signal from external thermocouple 52 against one or more predetermined thresholds to determine if the problem is with the embedded thermocouple 28 rather than the embedded heater 20, and if so, use external thermocouple 52 to subsequently monitor the operation of embedded heater 20. In some embodiments, rather than two thermocouples, there may only be one thermocouple, either embedded in or external to the nozzle body 12 for monitoring the heat profile of the nozzle melt bore (see FIG. 4 for example).

The embedded heater configuration shown in FIGS. 2 and 3 may be brazed in the spiral channel 22. Examples of nozzles having surface embedded heaters that may be employed in various applications of present invention can be seen in a number of the documents identified above in the Background section, including, for example, U.S. Pat. Nos. 5,266,023; 5,046,942; 6,162,043; 5,704,113; 4,771,164; 5,614,233; 4,768,283; 5,235,737; 4,557,685; 5,282,735; and 5,046,942.

The first or embedded heater carried by nozzle 10 could take a number of forms other than that shown in FIGS. 2 and 3. For example, FIG. 4 shows a further hot runner nozzle 130 that is similar to nozzle 10, except that the heater 20 is embedded internally within the nozzle body 12 in a high heat conductive insert 132. An example of such a heater configuration can be seen in U.S. Pat. No. 6,394,784. Nozzles having cast-in heaters, for example as such in U.S. Pat. Nos. 4,386,262; 4,238,671; and 4,403,405, could be used in applications of the present invention.

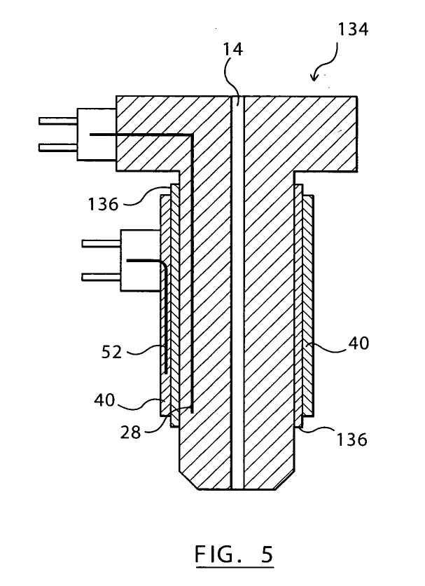

FIG. 5 shows yet a further hot runner nozzle 134, according to embodiments of the invention, which is similar to nozzle 10, except that the first heater is made up of one or more film heaters 136 that are secured to the outer surface of the nozzle body 12 to provide heat along the length of the melt bore 14. External clamp heater 40 is secured over the film heater 136. Example of nozzles having film heaters that could be adapted for use in the present invention can be seen, for example, in U.S. Pat. No. 5,973,296 issued Oct. 26, 1999; and U.S. Pat. No. 6,305,923 issued Oct. 23, 2001 (the contents of all of which are incorporated herein by reference).

The embedded heater could also take other forms, for example, induction heating systems could be used a heat pipe could be used, and axial cartridge heaters could be used.

The external heater 40 can also take a number of different forms other than that shown in FIG. 2. For example, many of the external heaters shown in the patent documents identified above in the Background section could be adapted for use in embodiments of the present invention. For example, band heaters configurations and external helical heater configurations such as those shown in U.S. Pat. Nos. 5,360,333; 5,411,392; 6,043,466 and 6,409,497 could be suitably adapted for use in embodiments of the invention. Film heater configurations could also be used in the external heater.

In some embodiments, the nozzle may have two independent embedded heaters, in addition to the external heater, to provide additional backup redundancy. By way of example, FIG. 7 shows another embodiment of a nozzle 150 according to the present invention. Nozzle 150 is similar to nozzle 10, except that an additional helical heater 152, terminating in terminal connections 154, is embedded in the surface of nozzle body 12 adjacent to and electrically independent from the first embedded heater 20. Clamp heater 40 extends over both the embedded heaters 20, 152. In one embodiment, controller 54 causes the second embedded heater 152 to provide heating to the nozzle body when the first embedded heater 20 malfunctions. In the event that the second embedded heater 152 then malfunctions, the external clamp heater 40 takes over. Examples of dual embedded heater configurations that could be employed in embodiments of the present invention are shown in U.S. Pat. No. 6,394,784 and EP Application No. 1 252 998 A2. In some embodiments, the two embedded heaters 20, 152 may be configured to work together to improve the heat profile along the length of the nozzle melt bore, in addition to or instead of as backup heaters to each other.

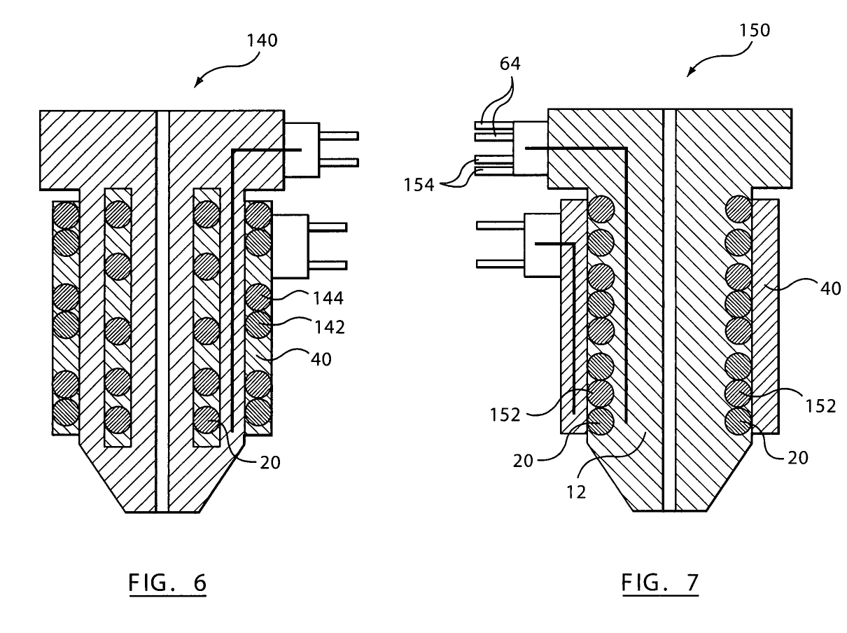

In some embodiments, an additional backup heater may also be used in clamp heater 40, and in this regard FIG. 6 shows a nozzle 140 according to a further embodiment of the invention. Nozzle 140 is similar to nozzle 130, except that the clamp heater 40 of nozzle 140 includes two electrically independent helical heating wires 142 and 144, to serve as backups for each other.

The nozzles of the present invention are, in preferred embodiments used in injection molding systems that are configured to provide access to the clamp heater and nozzles from a mold side of the system, such as shown in U.S. Pat. Nos. 6,162,043; 6,043,466; 6,309,207 and 5,533,882. In some embodiments, the nozzle may be configured to be removed from the mold side, such as shown in U.S. Pat. No. 6,162,043.

The above-described embodiments of the present invention are intended to be examples only. Alterations, modifications and variations may be effected to the particular embodiments by those skilled in the art without departing from the scope of the invention, which is defined by the claims appended hereto.

1. An injection molding heated nozzle comprising:
a nozzle body defining a melt channel;
a first heater securely attached to and supported by the nozzle body for heating a first portion of the melt channel; and
a second heater slidably attachable to the nozzle body for heating a second portion of the melt channel, such that the second heater at least partially overlaps the first heater.

2. The nozzle of claim 1, wherein the first heater is at least partially embedded in the nozzle body.

3. The nozzle of claim 2, wherein the first heater is located in a groove in the nozzle body.

4. The nozzle of claim 1, wherein the first heater is located around and in contact with an external surface of the nozzle body.

5. The nozzle of claim 4, wherein the first heater is a film heater.

6. The nozzle of claim 1, wherein the first portion of the melt channel heated by the first heater is substantially the same as the second portion of the melt channel heated by the second heater.

7. The nozzle of claim 6, wherein the second heater is electrically independent from the first heater.

8. The nozzle of claim 7, wherein at least one of the first and second heaters is alternatively operable to run simultaneously with and as a back-up to the other heater.

9. The nozzle of claim 7, wherein at least one of the first and second heaters is operable to run simultaneously with or as a back-up to the other heater.

10. The nozzle of claim 1, wherein the first heater includes two independent heaters.

11. The nozzle of claim 1, wherein the second heater includes two independent heaters.

12. The nozzle of claim 1, wherein the second heater is located on a sleeve that is clampable to the nozzle body.

13. The nozzle of claim 12, further comprising at least one thermocouple for monitoring the temperature of the first and/or second heater.

14. The nozzle of claim 13, wherein a first thermocouple is located on the clampable sleeve for monitoring the temperature of the second heater and a second thermocouple is positioned along the nozzle body for monitoring the temperature of the first heater.

15. An injection molding apparatus comprising:
an injection molding manifold;
a nozzle in fluid communication with the injection molding manifold at a first end and a mold gate of a mold cavity at a second end, the nozzle having a nozzle body defining a melt channel;
a first heater securely attached to and supported by the nozzle body for heating a first portion of the melt channel; and
a second heater slidably attachable to the nozzle body for heating a second portion of the melt channel, such that the second heater at least partially overlaps the first heater.

16. An injection molding heated nozzle comprising:
a nozzle body defining a melt channel;
a first heater securely attached to and supported by the nozzle body for heating a first portion of the melt channel; and
a second heater slidably attachable to the nozzle body for heating a second portion of the melt channel, wherein the second heater is movable along the nozzle body.

17. The nozzle of claim 16, wherein the second heater is positionable at least partially over the first heater.

18. The nozzle of claim 17 wherein the first portion of the melt channel heated by the first heater is substantially the same as the second portion of the melt channel heated by the second heater.

19. The nozzle of claim 16, wherein at least one of the first and second heaters is alternatively operable to run simultaneously with and as a back-up to the other heater.

20. The nozzle of claim 16, wherein at least one of the first and second heaters is operable to run simultaneously with or as a back-up to the other heater.
